(19) United States
(12) Patent Application Publication
(10) Pub. No.: US 2009/0175053 A1
(43) Pub. Date: Jul. 9, 2009

(54) Connector, light source module having the connector, and planar light source device

(75) Inventor: Isao Makuta, Shiga (JP)

Correspondence Address: OSHA LIANG L.L.P., TWO HOUSTON CENTER, 909 FANNIN, SUITE 3500, HOUSTON, TX, 77010, US

(73) Assignee: OMRON Corporation, Kyoto-shi (JP)

(21) Appl. No.: 11/629,421

(22) PCT Filed: Jun. 10, 2005
(86) PCT No.: PCT/JP2005/010704

§ 371 Date: Dec. 13, 2006

(30) Foreign Application Priority Data
Jun. 16, 2004 (JP) 2004-178949

(51) Int. Cl. G02B 6/00; H01R 13/502

(52) U.S. Cl. 362/630; 439/686; 362/551

(57) ABSTRACT

A connection terminal 39 includes a clip piece 73 and a fixed piece 71 facing each other in the vertical direction, the interval between a claw 74A and a claw 74B provided on the tips of the respective pieces is slightly smaller than the thickness of a flexible printed board 48. Therefore, when the flexible printed board 48 is inserted into a board insert port 68, the flexible printed board 48 is sandwiched and held by the claws 74A and 74B. The flexible printed board 48 is thus temporarily held in the state in which it is inserted in the connector. A projection 77 is projectedly provided on an end of an operation lever 46, and the flexible printed board 48 is provided with a cutout 79 into which the projection 77 is fitted. As a result, after the operation lever 46 is tilted horizontally to fit the projection 77 into the cutout 79, the flexible printed board 48 will not come out of the board insert port 68. Thus, the flexible printed board 48 can be reliably prevented from coming off by the anchoring mechanism in the locked state of the connector.

### TECHNICAL FIELD

The present invention relates to a connector for connecting a circuit board, a light source module having said connector, and a surface light source device constituted by said light source module and a light guide.

### BACKGROUND ART

A connector for connecting a wiring board having a lock mechanism is disclosed in Patent Document 1. FIGS. 1(a) to 1(d) are sectional views showing a structure of the connector and a method of operating the same in connecting a wiring board. A connector 11 includes a plurality of connection terminals 12 and an operation lever 13, and a wiring board 19 can be locked or unlocked to or from the connector 11 by rotating the operation lever 13.

Each of the connection terminals 12 is configured by connecting a base part of a clip piece 15 onto a fixed piece 14 through a support part 16, and a claw 17B projectedly provided on the tip of the fixed piece 14 faces a claw 17A projectedly provided on the tip of the clip piece 15. A lever 18 extends from the base part of the clip piece 15 in the opposite direction of the clip piece 15. When no load acts on the lever 18, the gap between the claws 17A and 17B is greater than the thickness of the flexible printed board 19, and the tip of the clip piece 15 is lowered to decrease the gap between the claws 17A and 17B when the lever 18 is pushed upward.

A cylindrical shaft part 20 is provided on a bottom surface of the operation lever 13, and said shaft part 20 is rotatably supported by a semi-circular groove part 21 provided on a top surface of the fixed piece 14. An active part 22 is provided on the tip of the operation lever 13, and the active part 22 faces a bottom surface of the lever 18.

As shown in FIG. 1(a), when the operation lever 13 is erected, since the active part 22 is away from the lever 18, the gap between the claws 17A and 17B is slightly greater than the thickness of the flexible printed board 19. Therefore, as shown in FIG. 1(b), when the flexible printed board 19 is inserted between the claws 17A and 17B, said flexible printed board 19 is smoothly inserted in an unloaded state without receiving a contact pressure from the claws 17A and 17B.

When the operation lever 13 is thereafter tilted, as shown in FIG. 1(c), the operation lever 13 rotates about the shaft part 20, and the active part 22 abuts on the bottom surface of the lever 18. When the operation lever 13 is further pushed down, the lever 18 is pushed up by the active part 22 and, as a reaction to this, the tip of the clip piece 15 is lowered about the support part 16 serving as a fulcrum. As a result, as shown in FIG. 1(d), the gap between the tip of the clip piece 15 and the fixed piece 14 is closed to sandwich the flexible printed board 19 between the claws 17A and 17B. At the same time, wirings on the flexible printed board 19 are electrically connected to the connection terminals 12 under a certain contact pressure.

The flexible printed board 19 can be smoothly inserted into the connector having such a structure because the flexible printed board 19 can be inserted in an unloaded state when inserted into the connector 11. Let us assume that P represents a contact pressure exerted on one connection terminal 12 and that the number of the connection terminals 12 (the number of poles) is N. Then, a contact pressure of P×N is exerted on the connector 11 as a whole, and the flexible printed board 19 is less likely to come off after being locked, the greater the number of poles N.

However, such a connector has had low operability because the flexible printed board must be locked with one hand while holding the flexible printed board and the connector with the other hand after the flexible printed board is inserted into the connector. Further, when used for a backlight, the connector has a small number of poles and a contact pressure exerted on the entire connector is also small. Therefore, even after a flexible printed board is connected to the connector, there has been a possibility that the connector will come off when it is pulled. In particular, in the case of an apparatus which must have a small size and high performance such as a portable telephone, components are mounted in a high density. When a backlight is incorporated in such an apparatus, it is frequently difficult to perform a locking operation as described above while holding a flexible printed board. Thus, the flexible printed board can come off before the locking operation after it is once connected to a connector, which has been a significant problem in manufacture.

Patent Document 1: JP-A-11-31561

### DISCLOSURE OF THE INVENTION

Problems that the Invention is to Solve

The invention has been made taking the above-described technical problem into consideration, and it is an object of the invention to provide a connector which allows a wiring board such as a flexible printed board to be temporarily held in a state in which it is inserted into the connector and which reliably prevents the wiring board from coming off with a stopper mechanism when the connector is locked.

### Means for Solving the Problems

The connector of the invention is characterized in that it includes an insert port for inserting a wiring board, a connection terminal electrically connected to a wiring on the wiring board inserted in said insert port, wiring board holding means for holding the wiring board by applying a contact pressure to the wiring board inserted in said insert port, and anchoring means for anchoring the wiring board such that said wiring will not come out said insert port.

Since the connector of the invention includes the wiring board holding means for holding the wiring board by applying a contact pressure to the wiring board inserted in the insert port, there is no need for holding the wiring board such that the wiring board will come out the insert port when the anchoring means is operated, and an operation of connecting the wiring board can therefore be easily carried out. Since the connector of the invention includes the anchoring means for anchoring the wiring board such that it will not come out the insert port, the wiring board will not easily come out even when it is pulled after the wiring board is connected to the connector.

Another embodiment of the connector according to the invention is characterized in that said connection terminal also serves as said wiring board holding means to hold the wiring board by applying a contact pressure to the wiring on the wiring board inserted in said insert port even with the wiring board unsecured by said anchoring means and in that said connection terminal is electrically connected to said wiring. In this embodiment, since the connection terminal also serves as said wiring board holding means to provide the function of holding the wiring board inserted in the insert port, the structure of the connector can be simplified.

Still another embodiment of the connector according to the invention is characterized in that said wiring board holding means is provided separately from said connection terminal. In this embodiment, since the connection terminal is separate from the board holding means, a configuration may be employed in which no contact pressure is applied to the wiring on said wiring board with the wiring board unsecured by the anchoring means, which facilitates the operation of inserting the wiring board. In addition, in the state in which the wiring board is secured by the anchoring means, the wiring board and the connector can be connected by applying a contact pressure to the wiring on said wiring board to establish electrical connection. In said embodiment, for example, the wiring board holding means may be provided at the insert port. With the wiring board holding means provided at the insert port, the wiring board held by the wiring board holding means does not come off the connector when it comes loose only slightly, which allows the wiring board to be reliably held.

Still another embodiment of the connector according to the invention is characterized in that said anchoring means comprises a cutout or through hole provided on said wiring board and an operating part having a projection which fits in said cutout or through hole to prevent the wiring board from coming off. In this embodiment, the wiring board is reliably prevented from coming off by the projection of the connector fitting in the cutout or through hole of the wiring board.

Still another embodiment of the connector according to the invention is characterized in that said anchoring means comprises a cutout or through hole provided on said wiring board and an elastic member which fits in said cutout or through hole to prevent said wiring board from coming off and in that said elastic member fits in the cutout or through hole of the wiring board when said wiring board is inserted into said insert port until it reaches a predetermined position. In this embodiment, since the elastic member fits in the cutout or through hole of the wiring board because of its elastic force to prevent the wiring board from coming off when the wiring board inserted up to the predetermined position from the insert port, the wiring board can be easily prevented from coming off, and operability is improved.

Still another embodiment of the connector according to the invention is characterized in that said connection terminal also serves as said wiring board holding means and said anchoring means and in that said connection terminal applies a contact pressure to the wiring on the wiring board to hold the wiring board when said wiring board is inserted from said insert port, is electrically connected to said wiring, and applies a greater contact pressure to the wire on the wiring board to anchor the wiring board such that it will not come off after the insertion of said wiring board is completed. In this embodiment, since the connection terminal also serves as the wiring board holding means and the anchoring means, there is no need for provide wiring board holding means and anchoring means separately from the connection terminal, and the structure of the connector can therefore be simplified. In this embodiment, when there are a great number of connection terminals (e.g., when there are ten or more poles), a greater anchoring force can be provided by the connection terminals. Therefore, a great advantage is achieved when there are a great number of connection terminals.

Still another embodiment of the connector according to the invention is characterized in that it includes a plurality of said connection terminals serving as both of said wiring board holding means and said anchoring means; some of said connection terminals hold the wiring board by applying a contact pressure to the wiring on the wiring board when said wiring board is inserted from said insert port and are electrically connected to said wiring and in that the rest of said connection terminals do not apply a contact pressure to the wiring on the wiring board when said wiring board is inserted from said insert port and applies a contact pressure to the wiring on the wiring board to anchor the wiring board such that it will not come off after the insertion of said wiring board is completed. In this embodiment, since the connection terminals also serve as the wiring board holding means and the anchoring means, there is no need for provide wiring board holding means and anchoring means separately from the connection terminals, and the structure of the connector can therefore be simplified. In addition, since the wiring board is held only by some of the connection terminals, it is not hard to insert the wiring board even when there are a great number of connection terminals, and the insertion of the wiring board can therefore be facilitated.

A light source module according to the invention is a light source module having a light-emitting element which emits light to supply light to a light guide, the light source module including a connector according to the invention and a conductive base for establishing continuity between said connector and said light-emitting element.

A surface light source device according to the invention includes a light source module according to the invention and a light guide to which light emitted by said light source module is introduced through a light entrance surface and which spreads the light into a planar shape and causes the light to exit from a light exit surface.

In the light source module and surface light source device according to the invention, a wiring board can be selected and connected to the connector according to the object to be achieved. It is therefore possible to use the light source module and the surface light source device in common. In addition, during an operation of connecting a wiring board to the light source module, the wiring board holding means always applies a contact pressure to the wiring board inserted in the insert port of the connector to hold the same. Therefore, it is not required to hold the wiring board such that the wiring board will not come out of the insert port until the anchoring means is operated, which makes it possible to significantly simplify steps of manufacturing apparatus having a high packaging density, in particular, portable telephones. Further, since the anchoring means allows a wiring board to be reliably locked after the wiring board is inserted, the wiring board does not come off the connector, and the product can therefore be provided with high reliability.

The above-described constituent elements of the invention may be arbitrarily combined as long as occasion permits.

### BRIEF DESCRIPTION OF THE DRAWINGS

FIG. 1(a), FIG. 1(b), FIG. 1(c); and FIG. 1(d) are sectional views showing a structure of a connector and a method of an operation of connecting a wiring board according to an example of the related art.

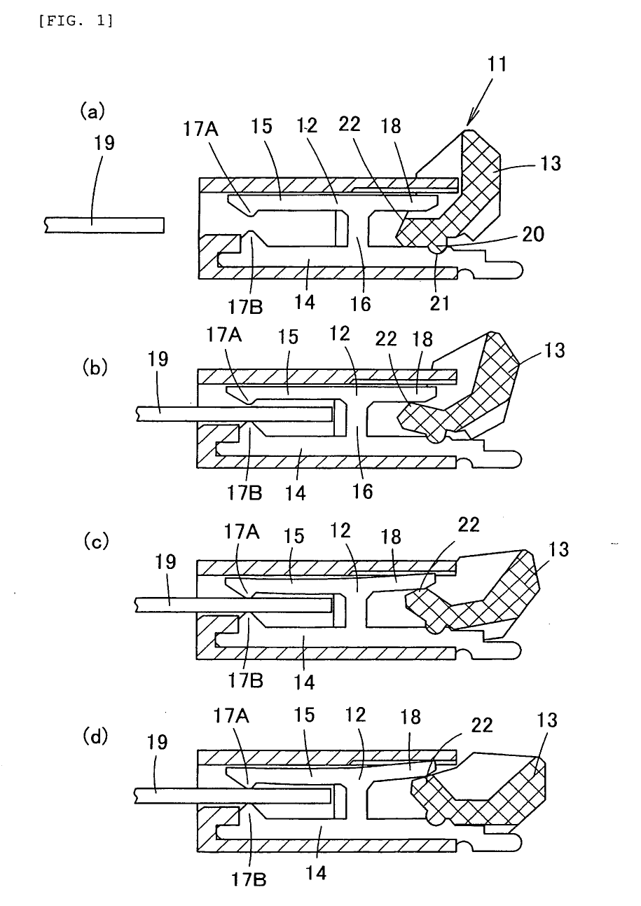

FIG. 2 is a perspective view showing a surface light source device according to Embodiment 1 of the invention.

FIG. 3 is an exploded perspective view of the surface light source device according to Embodiment 1.

FIG. 4 is a perspective view of a light source module according to Embodiment 1 of the invention taken from a front side of the same.

FIG. 5 is a perspective view of the light source module according to Embodiment 1 of the invention taken from a back side of the same.

FIG. 6 is a perspective view of a contact used in the light source module shown in FIG. 4.

FIG. 7(a) and FIG. 7(b) are a plan view and a front view of said contact.

FIG. 8 is a perspective view showing a structure of a light-emitting component.

FIG. 9 is a plan view showing a light-emitting component mounted in a housing of the light source module in FIG. 4.

FIG. 10(a) is a sectional view taken along the line X-X in FIG. 9, and FIG. 10(b) is a sectional view taken along the line Y-Y in FIG. 9.

FIG. 11 is a partially cutaway plan view showing the light source module mounted on a light guide.

FIG. 12 is a perspective view showing a state in which an operation lever is erected.

FIG. 13(a) is a plan view showing the state in which the operation lever is erected, the view omitting the operation lever, and FIG. 13(b) is a sectional view taken along the line Z-Z in FIG. 13(a).

FIG. 14(a) is a plan view showing a state in which a flexible printed board is inserted with the operation lever omitted, and FIG. 14(b) is a vertical sectional view of FIG. 14(a).

FIG. 15(a) is a plan view showing a state in which the operation lever is laid flat, the view omitting the operation lever, and FIG. 15(b) is a vertical sectional view of FIG. 15(a).

FIG. 16 is a circuit diagram showing a circuit configuration of the light source module.

FIG. 17 is a sectional view showing a modification of Embodiment 1.

FIG. 18(a) and FIG. 18(b) are a horizontal sectional view and a vertical sectional view showing a structure of a connector portion of a light source module of Embodiment 2 of the invention.

FIG. 19 is a horizontal sectional view explaining an operation of inserting a flexible printed board into a board insert port according to Embodiment 2.

FIG. 20(a) is a plan view showing a structure of a connector portion of a light source module of Embodiment 3, and FIG. 20(b) is a vertical sectional view of the same.

FIG. 21(a) is a plan view showing a state in which a flexible printed board is connected to the connector according to Embodiment 3, and FIG. 21(b) is a vertical sectional view of the same.

FIG. 22 is a graph showing a relationship between the number of connection terminals (number of poles) and a total contact pressure exerted on a flexible printed board by the connector.

FIG. 23 is a horizontal sectional view showing an internal structure of a connector according to Embodiment 4 of the invention.

FIG. 24 is a sectional view showing a state in which a flexible printed board is connected to the connector of Embodiment 4.

FIG. 25 is a sectional view showing a modification of Embodiment 4.

FIG. 26 is a schematic horizontal sectional view showing a structure of a connector according to Embodiment 5 of the invention.

FIG. 27(a) is a schematic horizontal sectional view explaining an operation of inserting a flexible printed board into the connector in Embodiment 5, and FIG. 27(b) is a sectional view of the same taken in the vertical direction.

FIG. 28(a) is a schematic horizontal sectional view showing a state in which the flexible printed board is connected to the connector in Embodiment 5, and FIG. 28(b) is a sectional view of the same taken in the vertical direction.

### DESCRIPTION OF REFERENCE NUMERALS

31: surface light source device
32: light source module
33: light guide
39: connection terminal
39A, 39B: connection terminal
40: light-emitting component
44: contact
44A: contact part
44B: contact part
45: housing
46: operation lever
48: flexible printed board
49: connector
68: board insert port
69: wiring
70: hole
71: fixed piece
72: support part
73: clip piece
74A, 74B: claw
79: cutout
82: spring piece
83: abutting stopper part
85: lever part
86: active part

### BEST MODE FOR CARRYING OUT THE INVENTION

Embodiments of the invention will now be described in detail according to the drawings. Obviously, the invention is not limited to the following embodiments.

### Embodiment 1

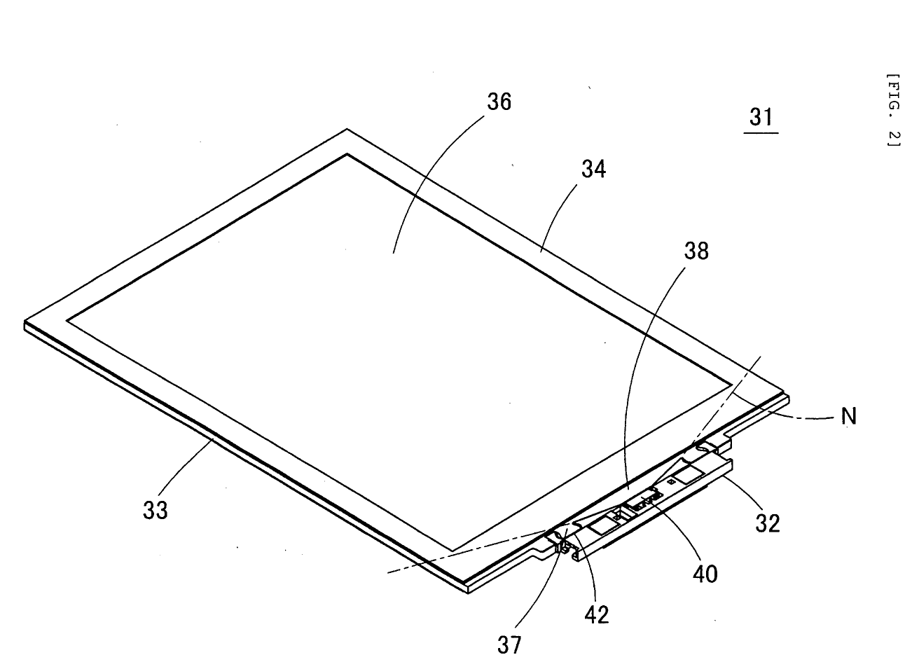

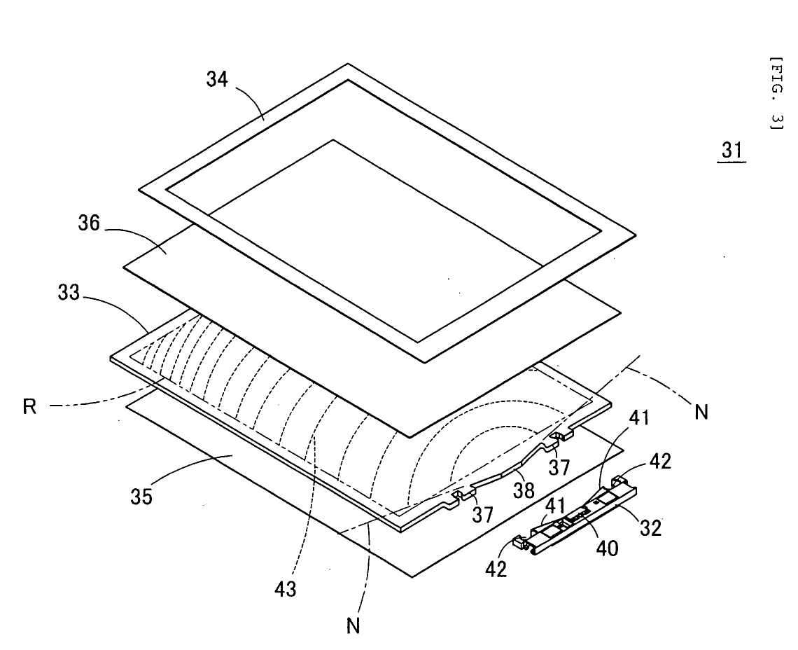

FIG. 2 is a perspective view showing a surface light source device 31 according to Embodiment 1 of the invention, and FIG. 3 is an exploded perspective view of the same. The surface light source device 31 comprises a light source module 32, a light guide 33, a rim sheet 34, and so on. The light guide 33 is formed from a transparent resin material having a high refractive index such as polymethylmethacrylate or polycarbonate resin, and patterns 43 are formed on a bottom surface of the light guide 33 to reflect light guided in the light guide 33 and to cause the light to exit a top surface (light exit surface) of the same. The patterns 43 are a multiplicity of microscopic concavities or convexities in the form of triangular prisms provided on the bottom surface of the light guide 33. Each of the patterns 43 is disposed on a concentric circle which is substantially centered on a light-emitting point of the light source module 32. The pattern density is low in a region near the light source module 32, and the pattern density gradually increases with the distance from the light source module 32. Luminance is thus made uniform on the light exit surface of the light guide 33.

Thus, light which has exited the light source module 32 enters the light guide 33 from a side surface (light entrance surface) of the light guide 33, and the light is guided by being repeatedly subjected to total reflection between the top and bottom surfaces of the light guide 33. A small amount of the light exits the light exit surface each time it is reflected by a pattern 43, and the light thus substantially uniformly exits the light exit surface of the light guide 33. The rim sheet 34 is formed like a frame, and it covers a peripheral part of the top surface of the light guide 33, in particular, a region of the light guide 33 where the patterns 43 are not formed on the bottom surface. A reflective sheet 35 is provided on the bottom surface of the light guide 33 as occasion demands, and a diffusing sheet 36, a prism sheet, or the like is provided between the light guide 33 and the rim sheet 34 as occasion demands.

A pair of connected portions 37 is provided on end faces of the light guide 33, those portions being inversely tapered from narrow base parts thereof toward their tips, and a trapezoidal light entrance part 38 is provided between the connected portions 37. A central region of the light entrance part 38 constitutes a light entrance surface, and inclined surfaces are formed on both sides thereof. In a plan view, lines N extending from the inclined surfaces on both sides of the light entrance part 38 (indicated by chain lines in FIG. 2 and FIG. 3) pass outside corners of inner periphery of the rim sheet 34 and inside corners of a region R of the bottom surface of the light guide 33 in which the patterns 43 are formed (and which is referred to as a pattern forming region and indicated by a chain double-dashed line surrounding the same in FIG. 3). As a result, beams of light incident on the light entrance surface and directed outwardly from the pattern forming region R are reflected by the inclined surfaces of the light entrance part 38 to be collected in the pattern forming region R, which reduces loss of light.

A central region of a front side of the light source module 32 is recessed in a trapezoidal shape, and a light-emitting component 40 is mounted in the middle of the same. Abutting parts 41, each of which is substantially trapezoidal, project forward on both sides of the light-emitting component 40. Connecting portions 42, which are inversely tapered from narrow entrances thereof, are provided in the form of recesses on the ends of the abutting parts 41.

The connected portions 37 of the light guide 33 are fitted into and mated with the connecting portions 42 of the light source module 32 from above to connect and integrate the light guide 33 and the light source module 32 as shown in FIG. 2. In order that the connected portions 37 are easily fitted in the connecting portions 42 at this time, edges of the top surfaces of the connecting portions 42 are chamfered. The light entrance part 38 of the light guide 33 is fitted in the gap between the abutting parts 41 of the light source module 32, and inclined surfaces of the abutting parts 41 are pressed against the inclined surfaces of the light entrance part 38. The front side of the light-emitting component 40 faces the light entrance part 38 of the light guide 33 in the state in which the connecting portions 42 and the connected portions 37 are coupled to secure the light source module 32 on the side surface of the light guide 33.

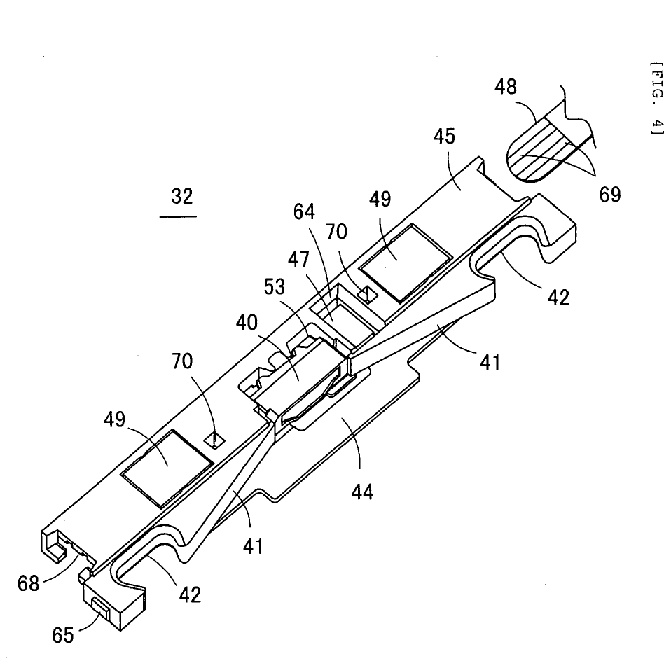

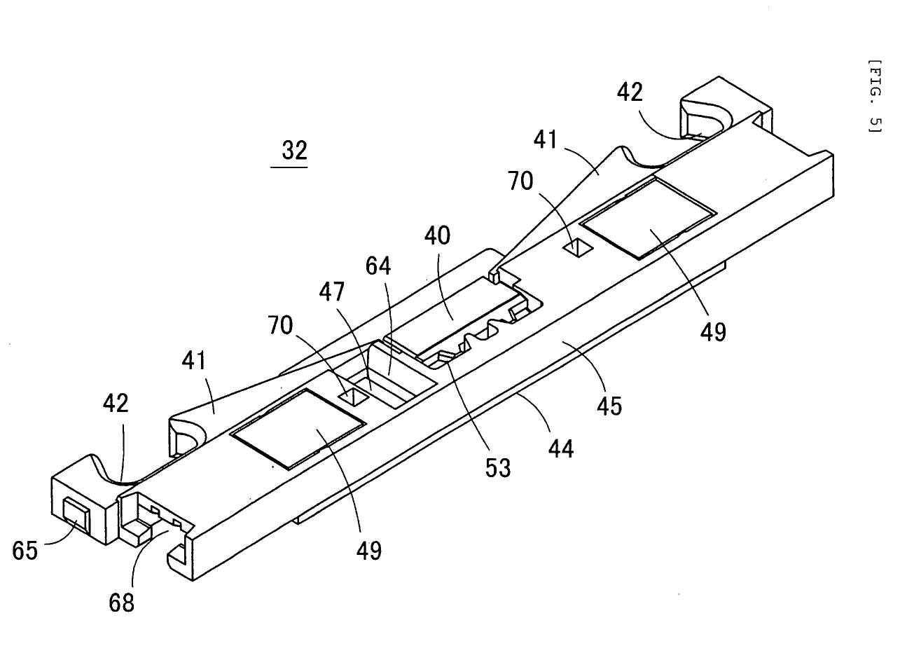

FIG. 4 is a perspective view of the light source module 32 taken from the front side thereof, and FIG. 5 is a perspective view of the light source module 32 taken from a back side thereof. The light source module 32 comprises a contact (conductive base) 44 made of a conductive material, a housing 45 made of a synthetic resin and attached to the contact 44, connectors 49, the light emitting component 40 which is mounted on the contact 44. and a Zener diode 47.

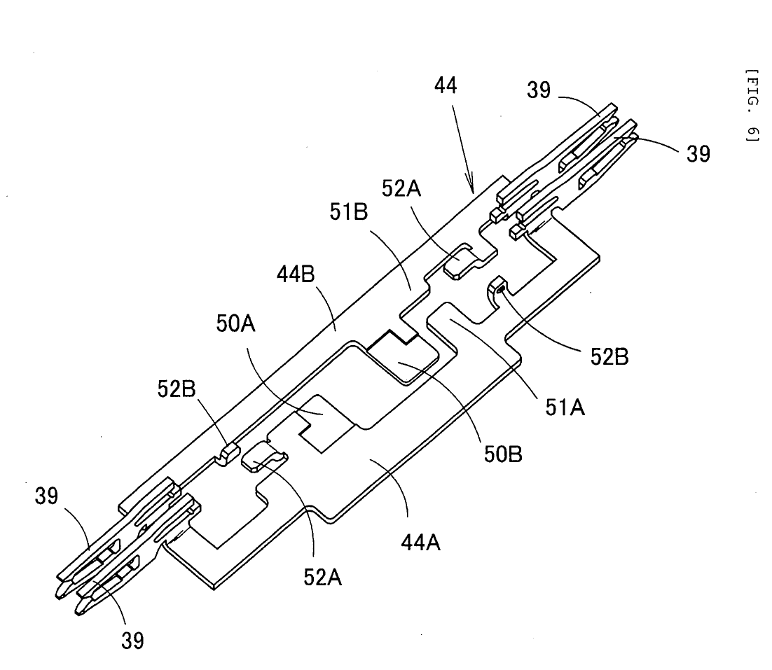

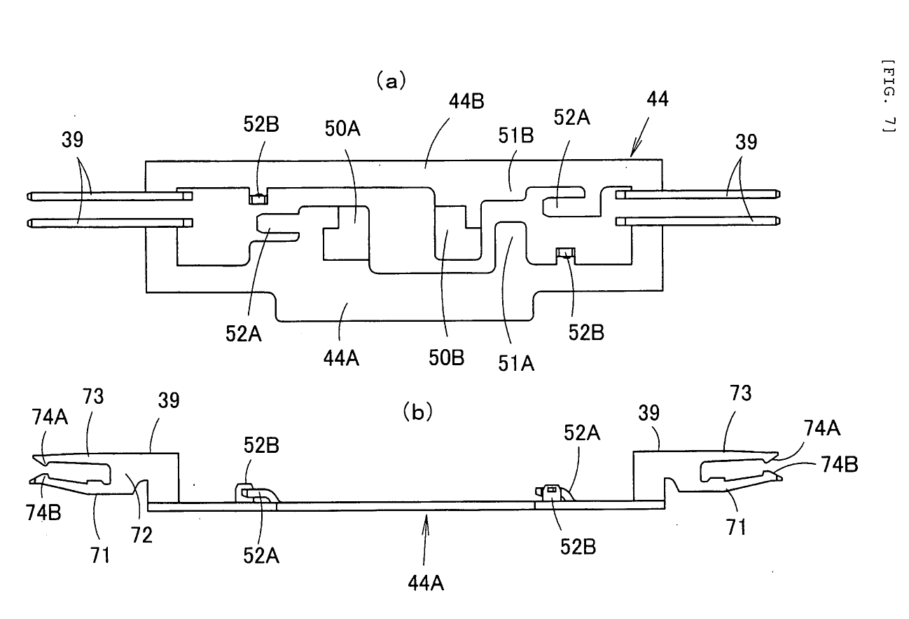

A structure of the contact 44 will be first described. FIG. 6 is a perspective view of the contact 44, and FIG. 7(a) and FIG. 7(b) are a plan view and a front view of the contact 44. The contact 44 is constituted by a first contact part 44A and a second contact part 44B which are disposed substantially parallel to each other with a gap left between them and which are both formed by pressing a metal sheet. Connection terminals 39 of respective connectors 49 are provided on both ends of both contact parts 44A and 44B. The connection terminals 39 are provided to hold a flexible printed board 48 and to electrically connect each of the contact parts 44A and 44B to wirings 69 on the flexible printed board 48. The connection terminal 39 may be provided only either of the left and right ends of the contact 44, which provides different types of modules, i.e., a type that is connected to a flexible printed board 48 on the right side thereof and a type that is connected to a flexible printed board 48 on the left side thereof. However, types of products can be reduced by providing the connection terminal 39 on both sides as shown in FIG. 6.

Light-emitting component mounting parts 50A and 50B for mounting the light-emitting component 40 are provided on both contact parts 44A and 44B, respectively, such that they constitute left and right parts facing each other. Zener diode mounting parts 51A and 51B for mounting the Zener diode 47 are provided such that they constitute front and rear parts facing each other. The light-emitting component mounting parts 50A and 50B are recessed at top surfaces thereof to reduce the thickness of them. The purpose is to keep the height (thickness) of the light source module 32 small by mounting the light-emitting component 40 in the region where the thickness is reduced. Reference numerals 52A and 52B indicate two sets of engaging pieces for mounting the housing 45 to the contact parts 44A and 44B. While the engaging pieces 52A and 52B have a structure which allows the housing 45 to be mounted with a single action, the housing 45 may be mounted using screws or the like. The reference numeral 70 shown in FIG. 4 or FIG. 5 indicate waste holes used for forming undercut parts provided to allow the mold for the housing 45 to be formed only by top and bottom molds.

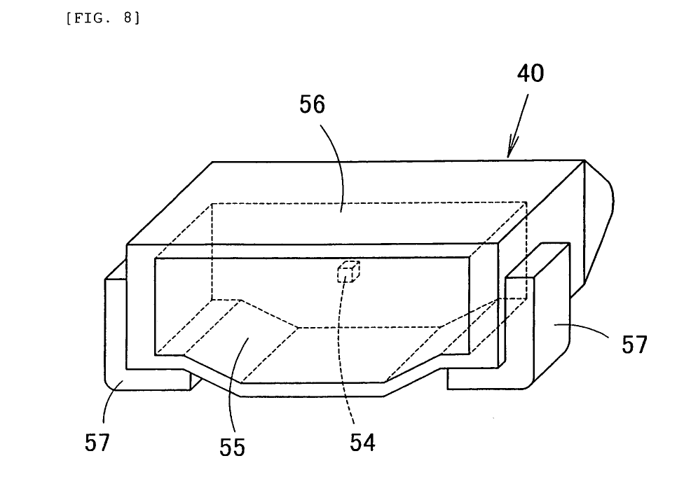

As shown in FIG. 4 and FIG. 5, the housing 45 mounted on the contact 44 has a recess or a light-emitting component containing part 53 which is located in the middle of the housing and is open on the front, top, and bottom sides of the same. The light-emitting component 40 is mounted on the contact 44 by placing the light-emitting component 40 in the light-emitting component containing part 53. FIG. 8 is a perspective view showing a structure of the light-emitting component 40. The light-emitting component 40 is provided by enclosing a light-emitting element 54 (bare chip) such as an LED in a transparent resin part 55, covering top, bottom, left and right sides of the transparent resin part 55 with a coating part 56 made of a white resin and leaving a front side of the transparent resin part 55 (a light-emitting side) uncovered by the coating part 56. Substantially L-shaped external terminals 57 are provided on both of left and right sides of the coating part 56 to extend on side and bottom surfaces thereof, and both of the external terminals 57 are in continuity to both electrodes of the light-emitting element 54.

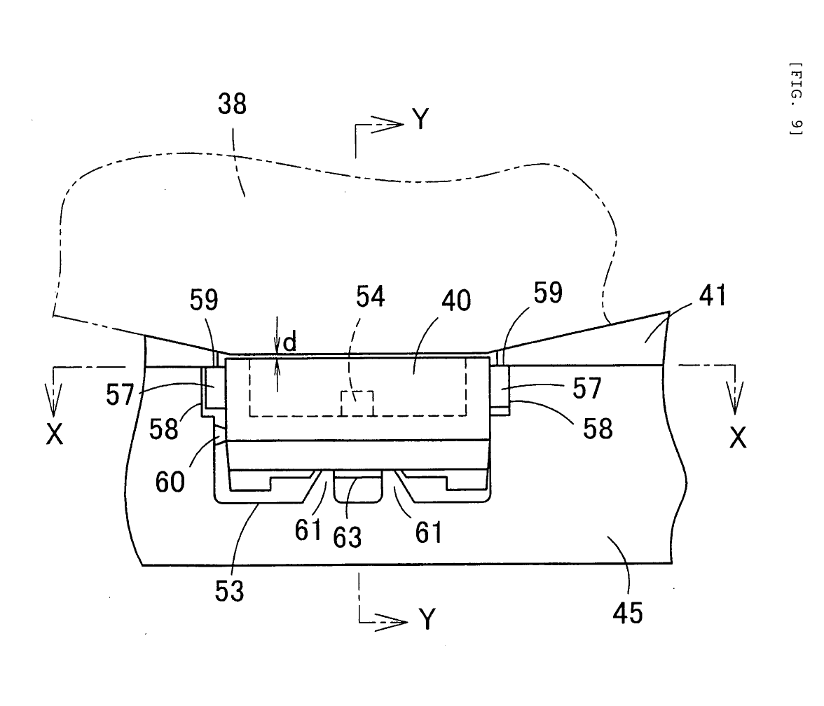

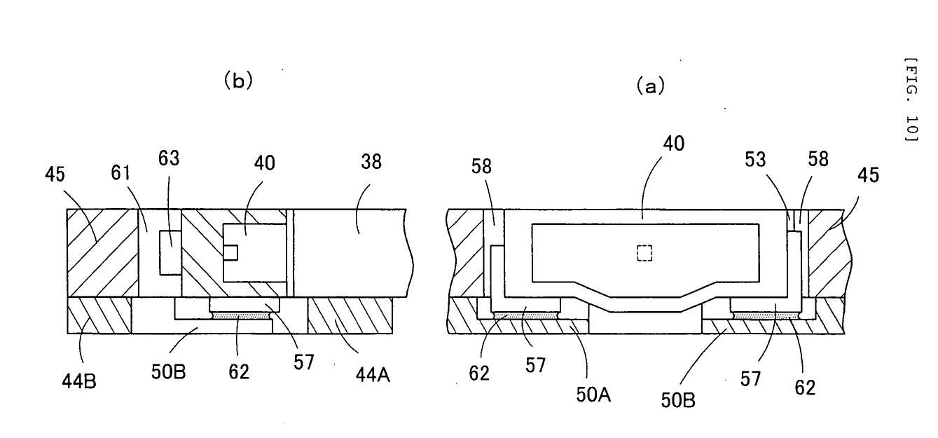

FIG. 9 is a plan view showing the light-emitting component 40 mounted in the housing 45. FIG. 10(a) is a sectional view taken along the line X-X in FIG. 9, and FIG. 10(b) is a sectional view taken along the line Y-Y in FIG. 9. Recessed parts 58 are formed on both sides of the light-emitting component containing part 53, and front surfaces of the recessed parts 58 constitute positioning surfaces 59. A convex part 60 is projectedly provided on one side surface in the recessed parts 58, and a pair of convex curved parts 61 is formed on rear surfaces in the recessed parts 58.

When the light-emitting component 40 is pushed into the light-emitting component containing part 53 from above, the external terminals 57 of the light-emitting component 40 are situated on the thin regions of the light-emitting component mounting parts 50A and 50B. Then, the light-emitting component mounting parts 50A and 50B and the bottom surfaces of the external terminals 57 are bonded using solder 62 as shown in FIG. 10, and the light-emitting component 40 is thus connected to the contact 44. Since the convex part 60 abuts on one side surface of the light-emitting component 40, the other side surface of the light-emitting component 40 is pressed against a side surface of the light-emitting component containing part 53. Thus, the light-emitting component 40 is prevented from shaking to the left and right, and the light-emitting component 40 is positioned in the light-emitting component containing part 53 in the left to right direction. Further, since the convex curved parts 61 abuts on a rear surface of the light-emitting component 40, front surfaces of the external terminals 57 are pressed against the positioning surfaces 59. Thus, the light-emitting component 40 is prevented from shaking back and forth, and the light-emitting component 40 is positioned in the light-emitting component containing part 53 in the front to rear direction. At this time, a projection 63 provided on a rear surface of the light-emitting component 40 fits in the gap between the convex curved parts 61.

The housing 45 has an opening constituting a Zener diode containing part 64 for containing the Zener diode 47, and the Zener diode mounting parts 51A and 51B are exposed at the Zener diode containing part 64. Therefore, the Zener diode 47 is mounted on the contact 44 by placing the Zener diode 47 in the Zener diode containing part 64 and soldering the Zener diode 47 to the Zener diode mounting parts 51A and 51B.

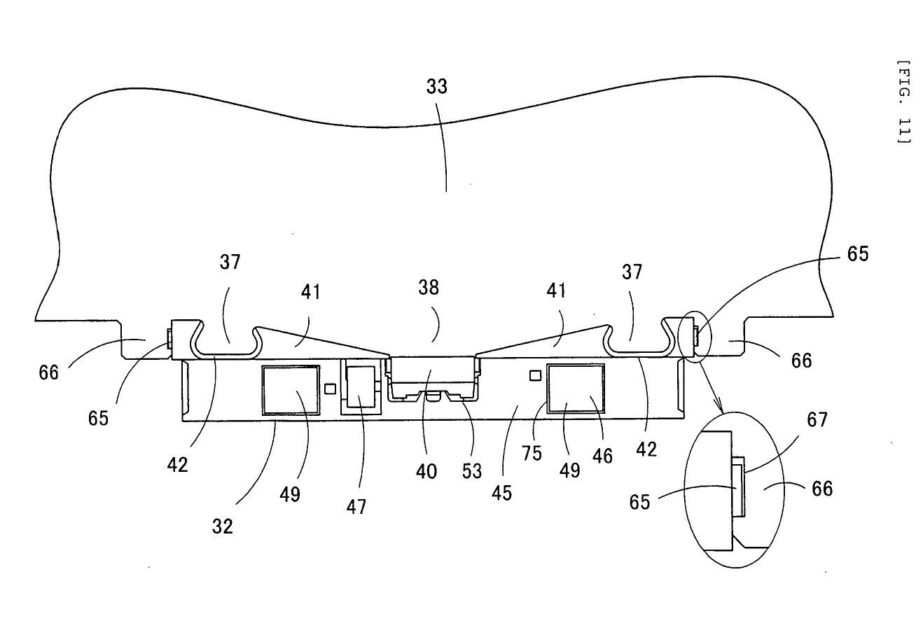

FIG. 11 shows the light source module 32 mounted on the light guide 33. The inclined surfaces of the abutting parts 41 provided on both sides of the light-emitting component containing part 53 have the same inclination as that of the inclined surfaces of the light entrance part 38 of the light guide 33. Therefore, when the connected portions 37 of the light guide 33 is pushed into the connecting portions 42 provided on the abutting parts 41 to engage the connecting portions 42 and the connected portions 37, the light source module 32 is pulled toward the light guide 33 to press the inclined surfaces of the abutting parts 41 against the inclined surfaces of the light entrance parts 38, as shown in FIG. 9. Since the inclined surfaces of the abutting parts 41 and the inclined surfaces of the light entrance part 38 are thus pressed against each other, the light source module 32 is positioned in the left to right direction, and the light-emitting component 40 is positioned such that the center of the light-emitting component 40 positioned in the light-emitting component containing part 53 coincides with the center of the front surface (light entrance surface) of the light entrance part 38. The light source module 32 can be accurately positioned relative to the light guide 33 also in the direction of rotation of the same.

The light source module 32 is positioned relative to the light guide 33 also in the front to rear direction by mounting the light source module 32 as thus described. Since the light-emitting component 40 is positioned in the front to rear direction with the front surfaces of the external terminals 57 thereof pressed against the positioning surfaces 59. The distance d between the front surface of the light entrance part 38 and the front surface of the light-emitting component 40 shown in FIG. 9 can be also maintained at a predetermined distance. In order to suppress luminance irregularities (variations of luminance) and interference fringes on the surface light source device 31, it is desirable to keep the distance d (referred to as spacing distance) between the front surface of the light entrance part 38 and the front surface of the light-emitting component 40 at 0.05 mm or less while preventing any contact between the front surface of the light entrance part 38 and the front surface of the light-emitting component 40.

Further, as shown in FIG. 4 and FIG. 5, engaging convex parts 65 project from side end faces of the abutting parts 41. As shown in FIG. 11, a projection 66 is provided on the light guide 33 outside each of the connected portions 37, and a concave part 67 is provided on an inner side surface of the projection 66. As indicated by the enlarged view in the elliptic frame in FIG. 11, the engaging convex part 65 abuts on a front surface of the concave part 67, whereby an end of the abutting part 41 is pulled toward the light guide 33.

As shown in FIG. 4 and FIG. 5, board insert ports 68 are provided on both ends of the housing 45 to allow the flexible printed board 48 to be inserted and connected to the connector 49. As shown in FIG. 7(a) and FIG. 7(b), a plurality of connection terminals 39 are disposed in parallel inside the board insert ports 68. Each of the connection terminals 39 is configured by connecting a base part of a clip piece 73 to a fixed piece 71 through a support part 72. The base end of the fixed piece 71 is secured to the contact parts 44A and 44B. A claw 74B is projectedly provided on the tip of the fixed piece 71, and a claw 74A is also projectedly provided on the tip of the clip piece 73. The claws 74A and 74B face each other.

The gap between the claw 74B provided on the fixed piece 71 and the claw 74A provided on the clip piece 73 is slightly smaller than the thickness of the flexible printed board 48. That is, when the flexible printed board 48 is inserted between the claws 74A and 74B associated therewith, the flexible printed board 48 can be smoothly inserted without receiving a great resistance. In addition, the claws 74A and 74B are provided at such an interval that the claws 74A on the clip pieces 73 and the wirings 69 on the flexible printed board 48 contact each other with a contact pressure at which stable electrical continuity is maintained between them after the flexible printed board 48 is inserted.

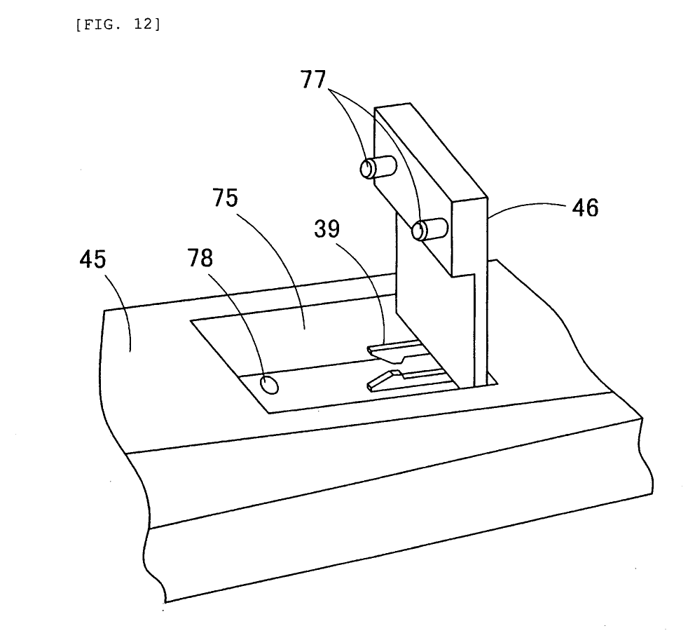

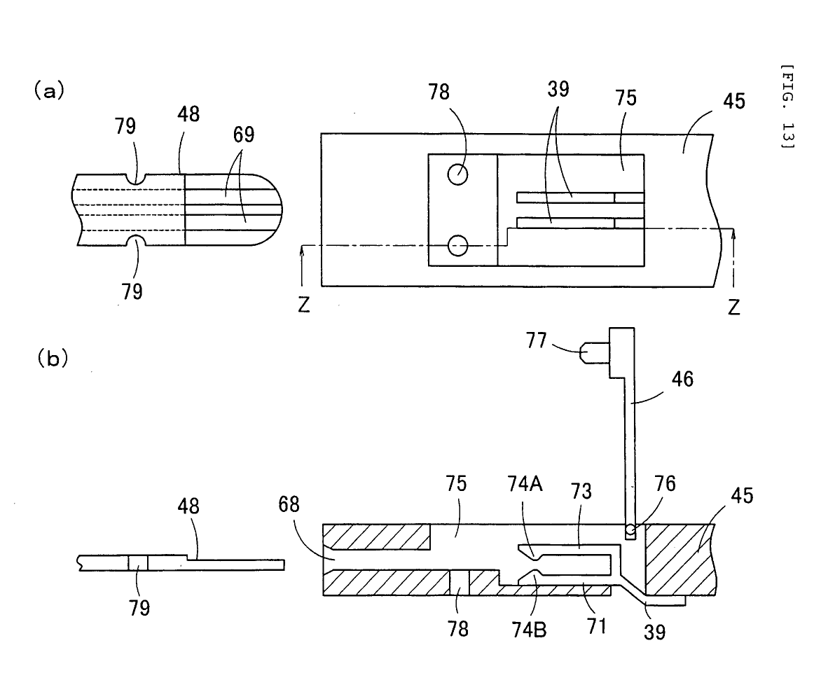

On the top surface of the housing 45, exposing windows 75 are provided to expose part of flexible printed boards 48 inserted in the board insert ports 68. Operation levers (operating parts) 46 of the connectors 49 are mounted in the open parts of said exposing windows 75 such that they can rotate about a shaft 76 (see FIG. 13(b)). FIG. 12 shows a state of an operation lever 46 in which it is erected upright. A pair of projections 77 is projectedly provided on an inner surface of the operation lever 46. On the bottom surface of the housing 45 exposed at the exposing window 75, holes 78 in which the projections 77 are to be fitted are provided so as to face said projections 77. As shown in FIG. 13(a), cutouts 79 in which said projections 77 can be fitted are provided in positions where the wirings 69 on the flexible printed board 48 do not pass (through holes may alternatively be employed).

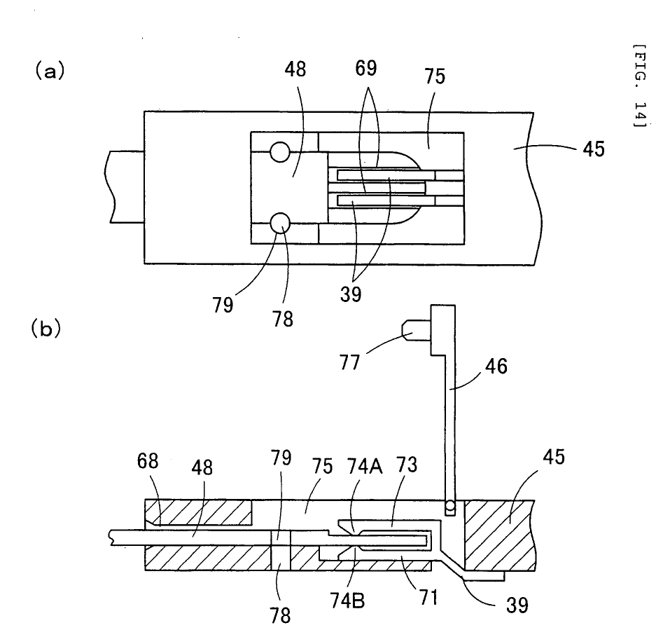

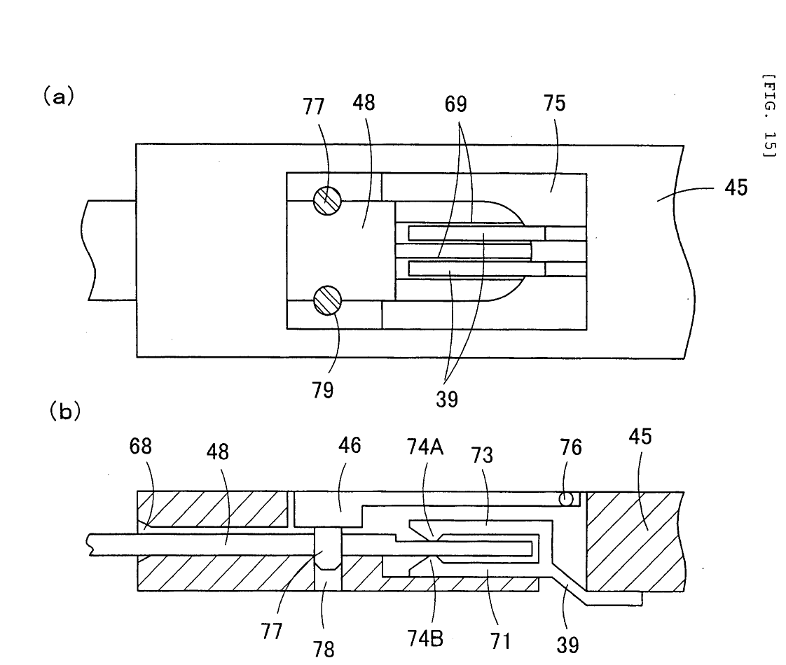

A flexible printed board 48 is connected to a connector 49 following a sequence as shown in FIG. 13(a), FIG. 13(b), FIG. 14(a), FIG. 14(b), FIG. 15(a), and FIG. 15(b). When the flexible printed board 48 is connected to the connector 49, as shown in FIG. 13(a) and FIG. 13(b), the operation lever 46 is erected to open the exposing window 75 on the side where connection is to be made. Then, the flexible printed board 48 is inserted into the board insert port 68, and the flexible printed board 48 is inserted between the fixed piece 71 and the clip piece 73 of each connection terminal 39 while observing it through the exposing window 75. When the flexible printed board 48 is inserted between the fixed pieces 71 and the clip pieces 73, as shown in FIG. 14(a) and FIG. 14(b), the claws 74A of the clip pieces 73 elastically contact wirings 69 on the flexible printed board 48 with a contact pressure, and each of the wirings 69 is electrically connected to the contact parts 44A and 44B. The flexible printed board 48 is sandwiched and caught by the upper and lower claws 74A and 74B and is thereby held such that it will not easily come out of the board inset port 68. At this time, the flexible printed board 48 is positioned such that the cutouts 79 thereof are aligned with the holes 78 in the exposing window 75.

Thereafter, as shown in FIG. 15(a) and 15(b), the operation lever 46 is tilted horizontally to fit the projections 77 into the cutouts 79 and the holes 78 of the flexible printed board 48 and to close the exposing window 75 with the operation lever 46. Since the flexible printed board 48 is held by the connection terminals 39 at this time, there is no need for holding the flexible printed board 48 to prevent it from coming off, and the operation lever 46 can be easily closed. When the operation lever 46 is thus closed, since the projections 77 are fitted in the cutouts 79 and the holes 78 of the flexible printed board 48, the flexible printed board 48 is prevented from coming off by the projections 77, and the flexible printed board 48 will not come off the connector 49 even if it is pulled. The flexible printed board 48 and the connector 49 are thus reliably connected.

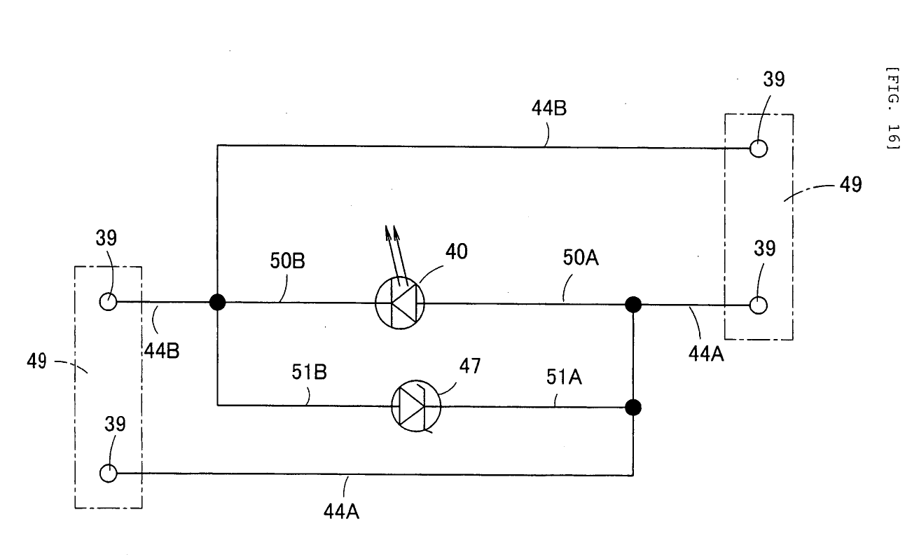

FIG. 16 is a diagram showing a circuit configuration of the light source module 32. The light-emitting component 40 and the Zener diode 47 are connected in parallel between the contact parts 44A and 44B, and two connection terminals 39 are led out from each of the contact parts 44A and 44B to form a connector 49 on the right and a connector 49 on the left. Therefore, a flexible printed board 48 may be connected to the connector 49 located on the right and may alternatively be connected to the connector 49 located on the left. Since the Zener diode 47 is parallel-connected to the light-emitting component 40, when an over-current or surge current flows from the connector 49, the over-current or the like flows through the diode 47 to protect the light-emitting component 40.

In the surface light source device 31 of the present embodiment, the light-emitting component 40 and the flexible printed board 48 are separate from each other, and the light-emitting component 40 and the flexible printed board 48 can be connected by the connector 49 provided on the light source module 32. Therefore, a flexible printed board 48 in accordance with the specification to be met by the surface light source device may be connected to the light source module 32. Thus, only the flexible printed board 48 is to be manufactured in many variants or to be produced to orders, and the light source module 32 or the surface light source device 31 excluding the flexible printed board 48 may be common components. Therefore, the number of types of the light source module 32 and the surface light source device 31 and the stock of the same can be reduced, and inventory risks can be reduced with respect to the light source module 32 and so on.

For a user of the surface light source device 31, the use of the light source module 32 makes it possible to shorten the lead time of a new product utilizing a liquid crystal display panel from the development until the shipment of the product. For example, when a user designs a new product such as a portable telephone, the shape of the flexible printed board 48 is designed in consideration to the data of the light source module 32 (in particular, specifications for the connection of the connector 49) disclosed by the manufacture of the surface light source device. Then, the flexible printed board 48 is internally produced or directly ordered from the manufacturer of the flexible printed board 48, and the surface light source device 31 excluding the flexible printed board 48 is ordered from the manufacturer of the surface light source device 41 with the size of the light guide 33 and so on specified. As a result, the time of delivery from the manufacturer of the surface light source device can be made quite short because there is no need for designing the flexible printed board 48 in detail before manufacturing the same. Further, the user can quickly order the flexible printed board 48 because it is not required to have meetings with the manufacturer of the surface light source device for deciding details of the flexible printed board 48. Therefore, the lead time before the shipment of the new product can be shortened even when the operation of connecting the light source module 32 and the flexible printed board 48 must be carried out at the user.

The light-emitting component 40 and the flexible printed board 48 are provided separately to allow only the flexible printed board 48 to be connected later. Thus, a flexible printed board for a liquid crystal panel and a flexible printed board for a surface light source device can be integrated.

Although one light-emitting component 40 is mounted on the light source module 32 in the above-described embodiment, a plurality of the light-emitting components 40 may alternatively be mounted on the light source module 32.

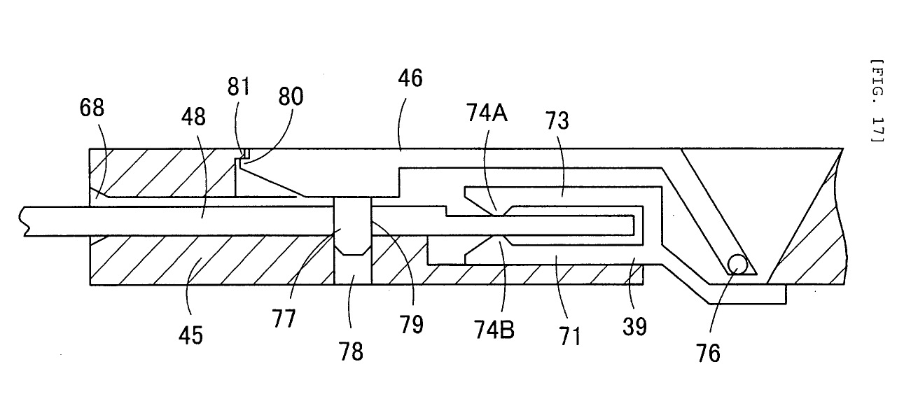

FIG. 17 shows a modification of Embodiment 1 in which an engaging claw 80 is provided at the tip of the operation lever 46 and in which an engaged part 81 is provided on an edge of the exposing window 75. After the projections 77 are fitted in the cutouts 79 of the flexible printed board 48, the engaged part 81 is engaged with the engaging claws 80 on the operation lever 46. Thus, the projections 77 are prevented from coming out of the cutouts 79 when the operation lever 46 opens accidentally.

### Embodiment 2

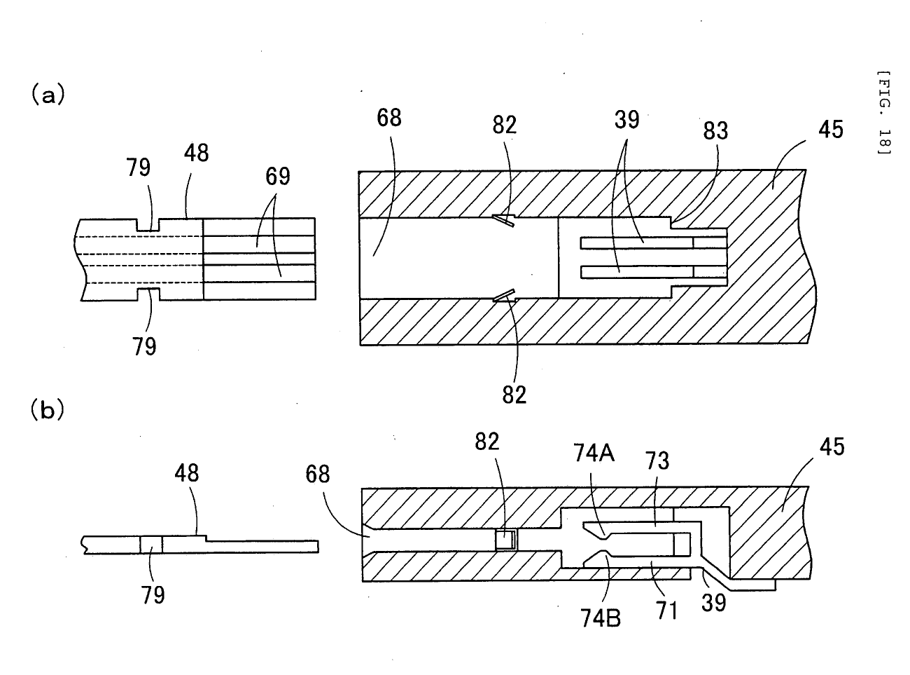

FIG. 18(a) and FIG. 18(b) are horizontal sectional view and a vertical sectional view showing a structure of the region of a connector of a light source module according to Embodiment 2 of the invention. In this embodiment, cutouts 79 in the form of square grooves are provided on both side surfaces of a flexible printed board 48. Spring pieces 82 having elasticity are provided on both side surfaces inside a board insert port 68. The spring pieces 82 have a fixed end on the side of the opening of the board insert port 68 and a free end on the side of connection terminals 39, and the length of the spring pieces 82 is slightly smaller than the length of the cutouts 79.

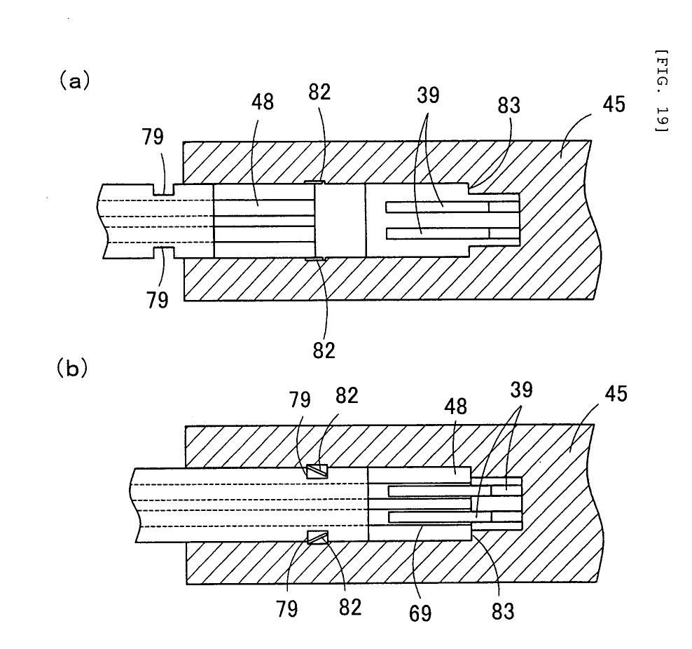

When the flexible printed board 48 is inserted into the board inset port 68 and the leading end of the flexible printed board 48 reaches the spring pieces 82 as shown in FIG. 19(a), the spring pieces 82 are retracted by being pushed by the flexible printed board 48. When the flexible printed board 48 is pushed further, the flexible printed board 48 is sandwiched and elastically held by claws 74A of clip pieces 73 and claws 74B of fixed pieces 71. At the same time, the claws 74A contact wirings 69 on the flexible printed board 48 with a contact pressure to electrically connect the wirings 69 to contact parts 44A and 44B. When the cutouts 79 on the flexible printed board 48 reach the position of the spring pieces 82 as shown in FIG. 19(b), the spring pieces 82 protrude into the cutouts 79 to be caught by the cutouts 79, and the flexible printed board 48 thus becomes unremovable even if someone tries to pull it out. The housing 45 may be provided with an abutting stopper part 83 which can abut on the flexible printed board 48 to stop the same in the position in which the cutouts 79 and the spring pieces 82 are aligned and the spring pieces 82 protrude into the cutouts 79.

### Embodiment 3

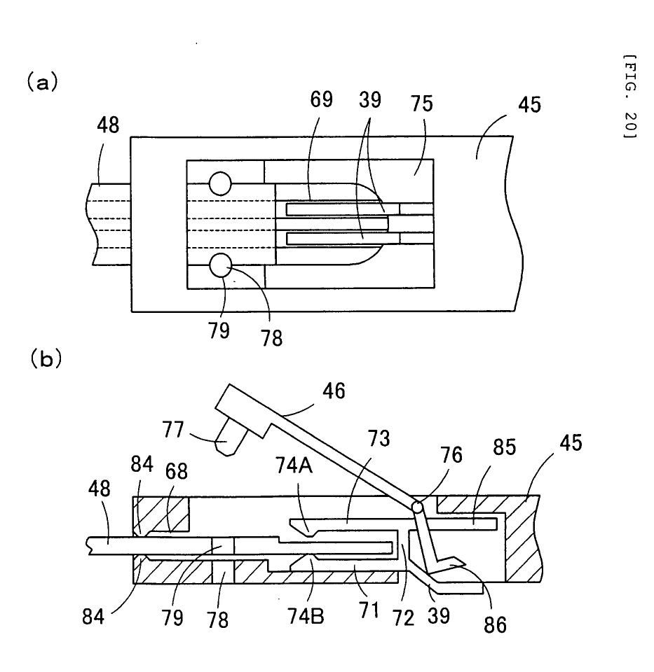

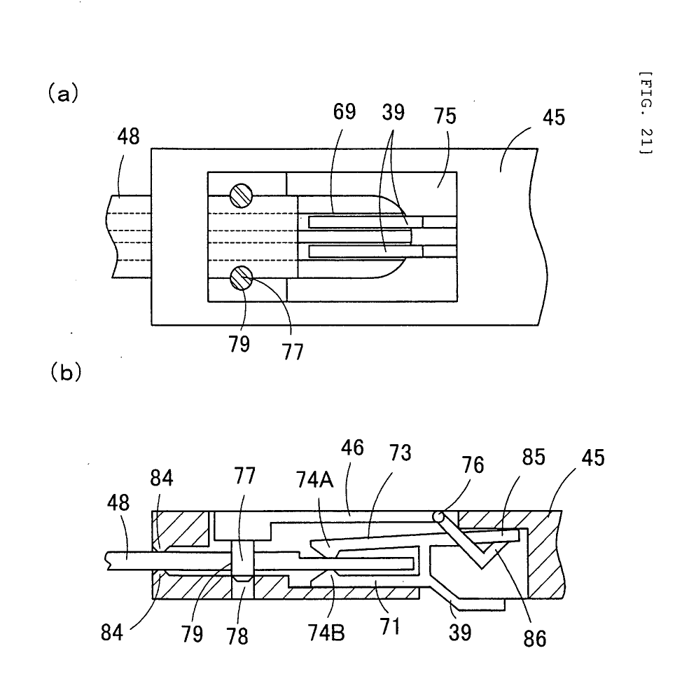

FIG. 20(a) and FIG. 21(a) are plan views showing a structure of the region of a connector (excluding an operation lever 46) of a light source module according to Embodiment 3 of the invention, and FIG. 20(b) and FIG. 21(b) are vertical sectional views of the same. In Embodiment 3, connection terminals 39 and board holding means are structures separate from each other. Specifically, the interval between claws 74A of clip pieces 73 and claws 74B of fixed pieces 71 is greater than the thickness of a flexible printed board 48 in an unloaded state. A pair of holding projections 84 is projectedly provided on inner top and bottom surfaces of a board insert port 68, the projections contacting top and bottom surfaces of the flexible printed board 48 inserted into the board insert port 68 with a contact pressure to hold the flexible printed board 48 by sandwiching the flexible printed board 48 from above and below. Thus, the interval between the top and bottom holding projections 84 is smaller than the thickness of the flexible printed board 48.

At each of the connection terminals 39, a lever part 85 extends from the base end of the clip piece 73 in the opposite direction of the clip piece 73. An active part 86, which is bent in the form of a dogleg, extends from the base end of the operation lever 46 in the opposite direction of the operation lever 46, and the tip of the active part 86 faces a bottom surface of the lever part 85.

When the flexible printed board 48 is inserted into the board insert port 68 with the operation lever 46 erected, as shown in FIG. 20(a) and FIG. 20(b), the flexible printed board is sandwiched by the holding projections 84 from above and below at the board insert port 68 to be held such that it will not come out of the board insert port 68. At this time, the flexible printed board 48 is not sandwiched between the claws 74A of the clip pieces 73 and the claws 74B of the fixed pieces 71. When cutouts 79 on the flexible printed board 48 are aligned with holes 78 and the operation lever 46 is tilted horizontally as shown in FIG. 21(a) and FIG. 21(b), the projections 77 provided on the operation lever 46 fit in the cutouts 79 of the flexible printed board 48 to prevent the flexible printed board 48 from coming off. At the same time, the active part 86 provided on the operation lever 46 abuts on the bottom surfaces of the lever parts 85 to push the lever parts 85 upward. When the lever parts 85 are pushed up, the tips of the clip pieces 73 are lowered as a reaction to the same, and the claws 74A contact wirings 69 on the flexible printed board 48 with an appropriate contact pressure to make electrical contact with the wirings 69.

A connector 49 having such a structure also allows a flexible printed board 48 to be held when the flexible printed board 48 is inserted into the board insert port 68. Therefore, the operation of connecting the flexible printed board 48 can be facilitated. Further, there is no possibility that the flexible printed board 48 will come off after the projections 77 are fitted into the holes 78. Since the active part 86 for pushing the lever parts 85 upward is formed integrally with the operation lever 46, the number of components can be reduced to reduce the size and cost of the connector 49. In addition, the number of manufacturing steps can be reduced because the locking operation for preventing the flexible printed board 48 from coming off and the press-fitting operation to establish electrical connection can be carried out at the same time.

It is also possible in Embodiment 3 to use spring pieces as described in Embodiment 2 as anchoring means instead of the projections 77.

### Embodiment 4

In the above-described embodiments, only one light-emitting component is mounted on a light source module. In some applications, however, it is desirable to mount a plurality of light-emitting components on a light source module and to switch emission from the light-emitting components appropriately as occasion demands. For example, it is desirable to mount a plurality of light-emitting components emitting white light and to switch the number of the light-emitting components turned on according to required brightness in some cases. In other cases, it may be desirable to mount a plurality of light-emitting components emitting in different colors and to switch the emission colors by switching the light-emitting components appropriately. In such cases, the number of wirings on a flexible printed board and the number of connection terminals are increased according to the number of light-emitting components.

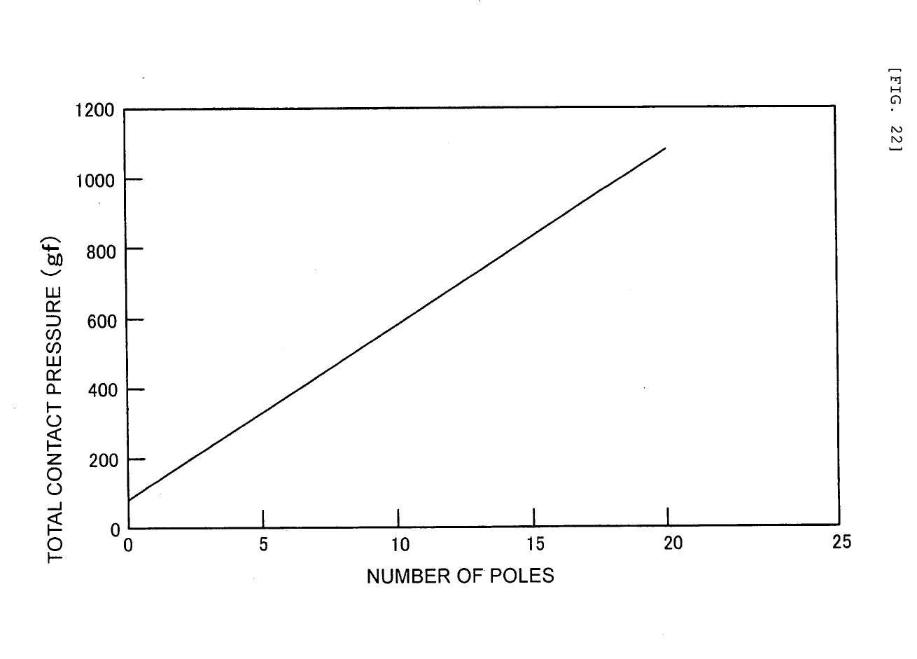

In such cases, when the connection terminals 39 are provided with the function of the board holding means as in Embodiment 1, the total contact pressure of the connection terminals increases substantially proportionately to the number of the connection terminals as shown in FIG. 22. Therefore, it becomes more difficult to insert a flexible printed board into a connector, the greater the number of connection terminals. Embodiment 4 solves such a problem.

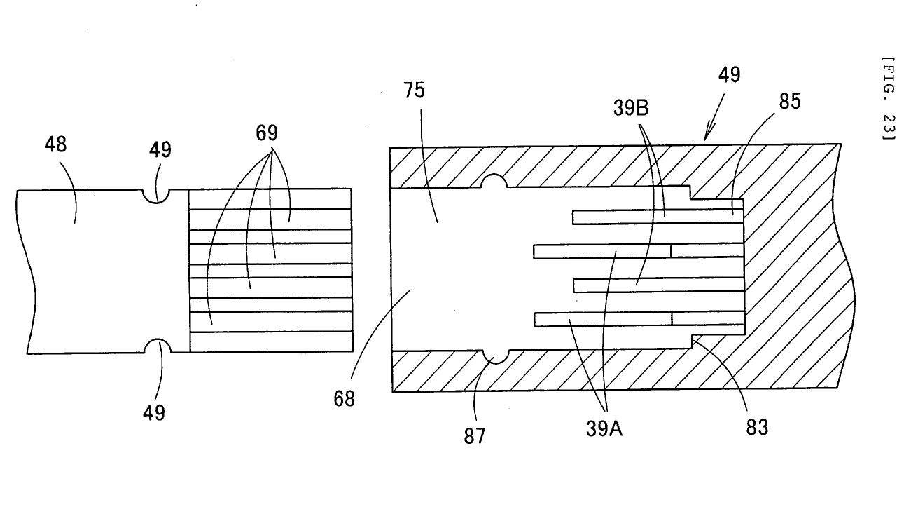

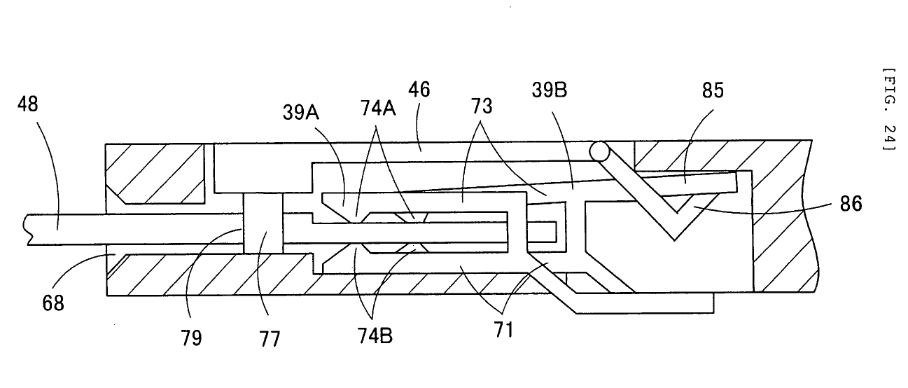

FIG. 23 is a horizontal sectional view showing an internal structure of a connector 49 according to Embodiment 4 of the invention, and FIG. 24 is a sectional view showing a state in which a flexible printed board 48 is connected to said connector 49. In this embodiment, four wirings 69 are provided on the flexible printed board 48, and cutouts 79 are provided on both sides of the same so as to avoid the wirings 69. Four connection terminals 39A and 39B constituting two sets are provided in the connector 49. The interval between claws 74A and 74B of the connection terminals 39A is smaller than the thickness of the flexible printed board 48 in an unloaded state, and said connection terminals 39A have the function of the board holding means. The interval between claws 74A and 74B of the other connection terminals 39B is greater than the thickness of the flexible printed board 48 in an unloaded state, and the connection terminals 39B do not have the function of the board holding means. Concave parts in which projections 77 are fitted are provided in an exposing window 75. An active part 86 provided at the base end of an operation lever 46 face bottom surfaces of lever parts 85 provided on the connection terminals 39B.

In Embodiment 4, when the flexible printed board 48 is inserted into the board insert port 68 with the operation lever 46 erected, the flexible printed board 48 is caught and held by part of the connection terminals 39A. At this time, since the flexible printed board 48 is caught by part of the connection terminals 39A, the force for inserting the flexible printed board 48 can be made small, and the flexible printed board 48 can be easily inserted even when the total number of the connection terminals 39A and 39B is great. When the operation lever 46 is tilted back to its initial position after the leading end of the flexible printed board 48 is put in abutment with an abutting stopper part 83, the projections 77 fit in the cutouts 79 and the concave parts 87 of the flexible printed board 48 to prevent the flexible printed board 48 from coming out of the board insert port 68. When the operation lever 46 is tilted, the lever part 85 of the connection terminal 39B is pushed upward by the active part 86 to sandwich the flexible printed board 48 between the claws 74A and 74B of the connection terminal 39B. As a result, each of the connection terminals 39A and 39B is electrically connected to a wiring 69.

As apparent from above, the holding force between the claws 74A and 74B of the connection terminals 39A may have such a magnitude that electrical contact with the wiring 69 can be maintained, and the number of the connection terminals 39A may be determined to provide the connection terminals 39A as a whole with a holding force having such a magnitude that the flexible printed board 48 will not accidentally come off.

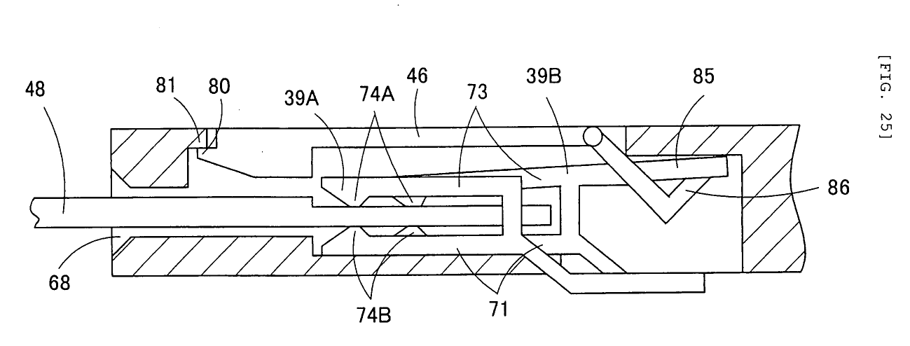

FIG. 25 is a modification of Embodiment 4. Although the flexible printed board 48 is prevented from coming off by fitting the projections 77 into the cutouts 79 on the flexible printed board 48 in Embodiment 4, the connection terminals 39A and 39B may alternatively be provided with the function of the anchoring means instead of using the projections 77 as shown in FIG. 25. Specifically, the function of the board holding means is provided by the connection terminal 39A whose claws 74A and 74B are spaced at an interval smaller than the thickness of the flexible printed board 48 in an unloaded state as described above. On the contrary, the interval between the claws 74A and 74B of the connection terminals 39B is greater than the thickness of the flexible printed board 48 in an unloaded state, and the interval between the claws 74A and 74B becomes smaller than the thickness of the flexible printed board 48 to hold the flexible printed board 48 with the claws 74A and 74B when the lever parts 85 of the connection terminals 39B are pushed upward by the active part 86 of the operation lever 46. By setting said board holding force of the connection terminals 39B sufficiently great, the anchoring function can be formed by the connection terminals 39A and 39B as a whole. This modification is advantageous especially when there are a great number of connection terminals 39A and 39B (in particular, when there are ten or more terminals).

### Embodiment 5

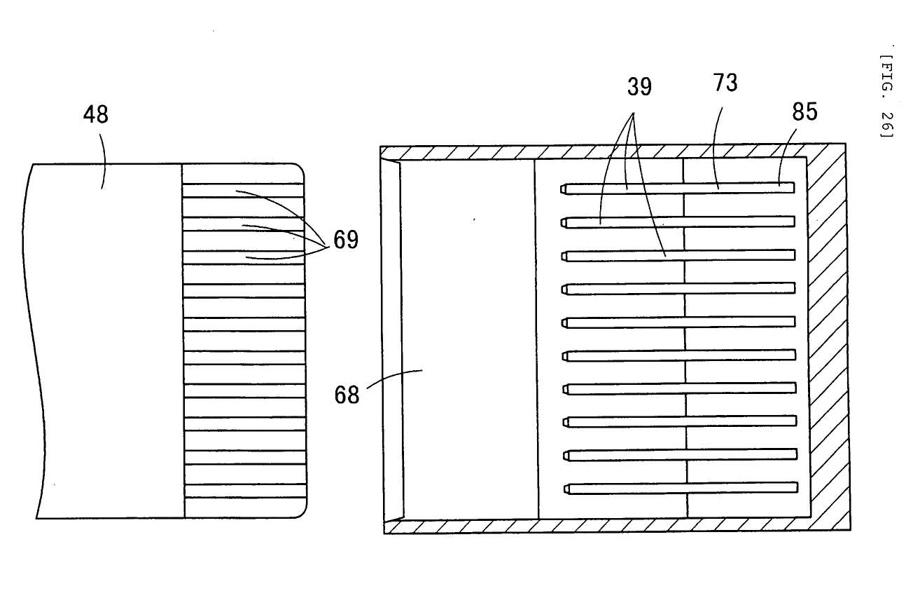

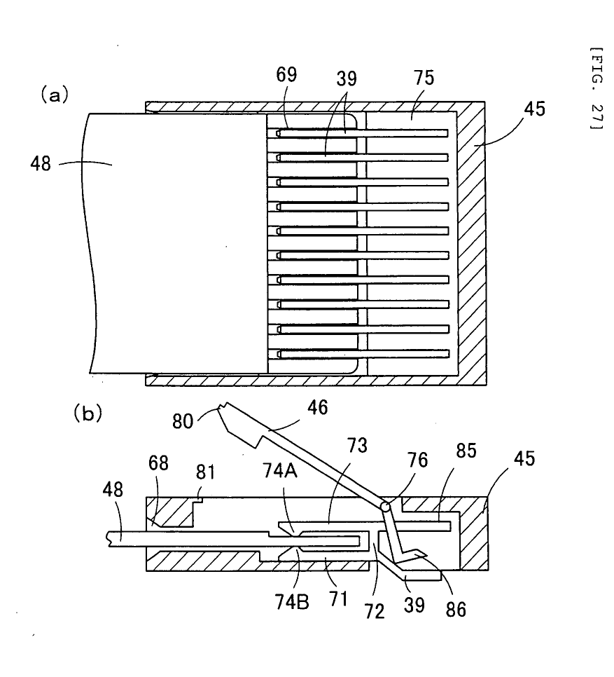

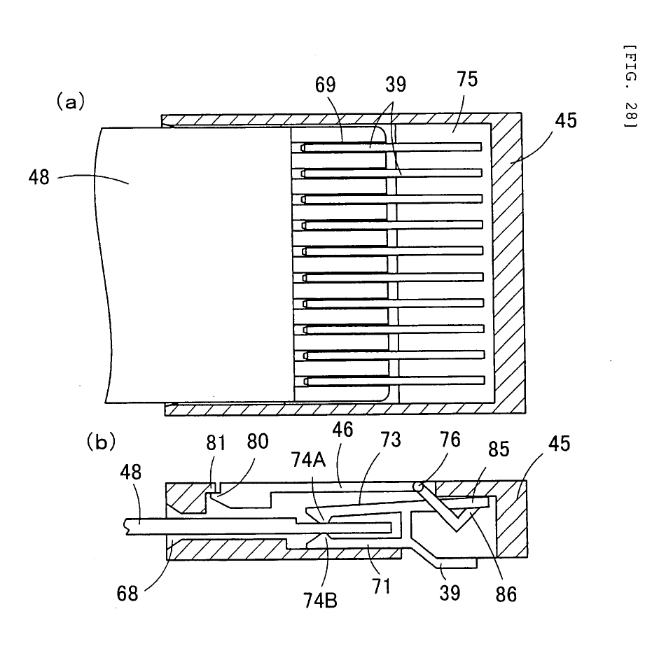

FIG. 26 is a schematic horizontal sectional view showing a structure of a connector according to Embodiment 5 of the invention (with an operation lever 46 omitted) . FIG. 27(a) and FIG. 28(a) are schematic horizontal sectional views explaining an operation of inserting a flexible printed board into the connector, and FIG. 27(b) and FIG. 28(b) are respective sectional views taken in the vertical direction. In this embodiment, a plurality of (e.g., ten or more) wirings 69 are provided on a flexible printed board 48. A connector 49 includes a plurality of (e.g., ten or more) connection terminals 39 accordingly. The interval between any pair of a claw 74A of a clip piece 73 and a claw 74B of a fixed piece 71 is slightly smaller than the thickness of the flexible printed board 48 in an unloaded state. A lever part 85 extends from the base end of a clip piece 73 in the opposite direction of the clip piece 73. An active part 86, which is bent in the form of a dogleg, extends from the base end of the operation lever 46 in the opposite direction of the operation lever 46, and the tip of the active part 86 faces a bottom surface of each of the lever parts 85.

In this embodiment, the connection terminals 39 serve as both of the board holding means and the anchoring means, and the flexible printed board 48 is connected as described below. When the flexible printed board 48 is inserted into a board insert port 68 with the operation lever 46 erected, as shown in FIG. 27(a) and FIG. 27(b), the flexible printed board 48 is sandwiched by the claws 74A of the fixed pieces 71 and the claws 74B of the clip pieces 73 from above and below and is thereby held such that it will not come out of the insert port 68. The claws 74A contact the wirings 69 with an appropriate contact pressure, and each of the wirings 69 is electrically connected to the connector 49.

When the operation lever 46 is thereafter tilted horizontally, as shown in FIG. 28(a) and FIG. 28(b) , the active part 86 provided at the operation lever 46 abuts on the bottom surfaces of the lever parts 85 to push each of the lever parts 85 upward. When the lever parts 85 are pushed upward, the tips of the clip pieces 73 are lowered to urge the claws 74A against the flexible printed board 48 strongly, and the flexible printed board 48 is thus strongly held between the plural sets of claws 74A and 74B. In this embodiment, since there are a great number of connection terminals 39, the flexible printed board 48 as a whole is held with a great force, and it does not come out of the board insert port 68 even when pulled. Further, the operation lever 46 is kept in the horizontal state by an engaging claw 80 engaging an engaged part 81.

Since the connector 49 having such a structure also allows the flexible printed board 48 to be held when the flexible printed board 48 is inserted in the board insert port 68, the operation of connecting the flexible printed board 48 can be easily carried out. There is no possibility that the flexible printed board 48 will come off after the operation lever 46 is tilted horizontally to strongly fasten the claws 74A and 74B to each other.

1. A connector comprising an insert port for inserting a wiring board; a connection terminal electrically connected to a wiring on the wiring board inserted in said insert port; wiring board holding means for holding the wiring board by applying a contact pressure to the wiring board inserted in said insert port; and anchoring means for anchoring the wiring board such that said wiring will not come out said insert port.

2. A connector according to claim 1, characterized in that said connection terminal also serves as said wiring board holding means to hold the wiring board by applying a contact pressure to the wiring on the wiring board inserted in said insert port even with the wiring board unsecured by said anchoring means and in that said connection terminal is electrically connected to said wiring.

3. A connector according to claim 1, characterized in that said wiring board holding means is provided separately from said connection terminal.

4. A connector according to claim 3, characterized in that said wiring board holding means is provided at said insert port.

5. A connector according to claim 3, characterized in that no contact pressure is applied to the wiring on said wiring board in the state in which the wiring board is not secured by said anchoring means and in that the a contact pressure is applied to the wiring on said wiring board to establish electrical connection in the state in which the wiring board is secured by said anchoring means.

6. A connector according to claim 1, characterized in that said anchoring means comprises a cutout or through hole provided on said wiring board and an operating part having a projection which fits in said cutout or through hole to prevent the wiring board from coming off.

7. A connector according to claim 1, characterized in that:
said anchoring means comprises a cutout or through hole provided on said wiring board and an elastic member which fits in said cutout or through hole to prevent said wiring board from coming off; and
said elastic member fits in the cutout or through hole of the wiring board when said wiring board is inserted into said insert port until it reaches a predetermined position.

8. A connector according to claim 1, characterized in that:
said connection terminal also serves as said wiring board holding means and said anchoring means; and
said connection terminal applies a contact pressure to the wiring on the wiring board to hold the wiring board when said wiring board is inserted from said insert port, is electrically connected to said wiring, and applies a greater contact pressure to the wire on the wiring board to anchor the wiring board such that it will not come off after the insertion of said wiring board is completed.

9. A connector according to claim 1, characterized in that:
it includes a plurality of said connection terminals serving as both of said wiring board holding means and said anchoring means;
some of said connection terminals hold the wiring board by applying a contact pressure to the wiring on the wiring board when said wiring board is inserted from said insert port and are electrically connected to said wiring; and
the rest of said connection terminals do not apply a contact pressure to the wiring on the wiring board when said wiring board is inserted from said insert port and applies a contact pressure to the wiring on the wiring board to anchor the wiring board such that it will not come off after the insertion of said wiring board is completed.

10. A light source module having a light-emitting element which emits light to supply light to a light guide, characterized in that it comprises:
a connector according to claim 1; and
a conductive base for establishing continuity between said connector and said light-emitting element.

11. A surface light source device comprising:
a light source module according to claim 10; and
a light guide to which light emitted by said light source module is introduced through a light entrance surface and which spreads the light into a planar shape and causes the light to exit from a light exit surface.

12. A light source module having a light-emitting element which emits light to supply light to a light guide, characterized in that it comprises:
a connector according to claim 2; and
a conductive base for establishing continuity between said connector and said light-emitting element.

13. A light source module having a light-emitting element which emits light to supply light to a light guide, characterized in that it comprises:
a connector according to claim 3; and
a conductive base for establishing continuity between said connector and said light-emitting element.

14. A light source module having a light-emitting element which emits light to supply light to a light guide, characterized in that it comprises:
a connector according to claim 4; and
a conductive base for establishing continuity between said connector and said light-emitting element.

15. A light source module having a light-emitting element which emits light to supply light to a light guide, characterized in that it comprises:
a connector according to claim 5; and
a conductive base for establishing continuity between said connector and said light-emitting element.

16. A light source module having a light-emitting element which emits light to supply light to a light guide, characterized in that it comprises:
a connector according to claim 6; and
a conductive base for establishing continuity between said connector and said light-emitting element.

17. A light source module having a light-emitting element which emits light to supply light to a light guide, characterized in that it comprises:
a connector according to claim 7; and
a conductive base for establishing continuity between said connector and said light-emitting element.

18. A light source module having a light-emitting element which emits light to supply light to a light guide, characterized in that it comprises:
a connector according to claim 8; and
a conductive base for establishing continuity between said connector and said light-emitting element.

19. A light source module having a light-emitting element which emits light to supply light to a light guide, characterized in that it comprises:
a connector according to claim 9; and
a conductive base for establishing continuity between said connector and said light-emitting element.
